(19) United States
(12) Patent Application Publication
(10) Pub. No.: US 2015/0135218 A1
(43) Pub. Date: May 14, 2015

(54) DISPLAY APPARATUS AND METHOD OF CONTROLLING THE SAME

(71) Applicant: SAMSUNG ELECTRONICS CO., LTD., Suwon-si (KR)

(72) Inventors: So-yon YOU, Seoul (KR); Hee-won KU, Seoul (KR); Youn-ji SHIM, Seoul (KR); Sung-jun HWANG, Suwon-si (KR); Young-in PARK, Gunpo-si (KR); Hee-kyoung SEO, Suwon-si (KR)

(73) Assignee: SAMSUNG ELECTRONICS CO., LTD., Suwon-si (KR)

(21) Appl. No.: 14/538,225

(22) Filed: Nov. 11, 2014

(30) Foreign Application Priority Data
Nov. 11, 2013 (KR) 10-2013-0136100
Jan. 10, 2014 (KR) 10-2014-0003448
Jan. 10, 2014 (KR) 10-2014-0003453
May 23, 2014 (KR) 10-2014-0062158

(51) Int. Cl. H04N 21/482; H04N 21/6587; H04N 21/475

(52) U.S. Cl. CPC H04N 21/482; H04N 21/4751; H04N 21/6587; H04N 21/4756
USPC 725/40

(57) ABSTRACT

A display apparatus and a method of controlling a display apparatus are provided. The display apparatus includes a display configured to display a content and a controller configured to control the display to display the content by adding content-related information, that is generated based on at least one of user preference information and a user viewing trend, to the content. In addition, the content-related information may be generated based on at least one of user preference information and a user viewing trend.

### CROSS-REFERENCE TO RELATED APPLICATIONS

This application claims priority from Korean Patent Application No. 10-2013-0136100 filed on Nov. 11, 2013, Korean Patent Application No. 10-2014-0003448 filed on Jan. 10, 2014, 10-2014-0003453 filed on Jan. 10, 2014, and Korean Patent Application No. 10-2014-0062158 filed on May 23, 2014, the disclosures of which are incorporated herein by reference in their entireties.

### BACKGROUND

1. Field

Apparatuses and methods consistent with exemplary embodiments relate to a display apparatus and a method of controlling the same, and more particularly, to a display apparatus which provides content-related information and a method of controlling the same.

2. Description of Related Art

As electronic technologies continue to develop, various types of display apparatus are also being developed. In particular, display apparatuses such as a television (TV), a Personal Computer (PC), a laptop computer, a tablet PC, a mobile phone, a MP3 player, and the like, are commonly being used in a domestic environment.

Recently, in order to satisfy user needs with respect to more new and various functions, there is an effort to develop new display apparatuses. As an example, a method for providing a user with assistance using popular information of content is being provided by a display apparatus. However, according to the related art, the method may be perceived by a user as meaninglessly because the method indirectly provides information accumulated over a certain period of time through other mediums, for example, viewing ratings.

### SUMMARY

Exemplary embodiments overcome the above disadvantages and other disadvantages not described above. Also, an exemplary embodiment is not required to overcome the disadvantages described above, and an exemplary embodiment may not overcome any of the problems described above.

One or more exemplary embodiments provide a display apparatus which provides information which is meaningful to a user along with content, and a method of controlling the same.

According to an aspect of an exemplary embodiment, there is provided a display apparatus including a display configured to display content, and a controller configured to control the display to display the content by adding content-related information, that is generated based on at least one of user preference information and a user viewing trend, to the content.

The content-related information may be generated based on a user interaction. In addition, the user interaction may include a user interaction with respect to at least one of the content, an attribute of the content, and at least one object that is included in the content.

The content-related information may be a badge item that represents content attributes which are a basis for recommendation of content according to the user viewing trend.

The controller may display the badge item on an area of a screen and display a thumbnail with respect to at least one content which corresponds to the badge item on another area of the screen.

The controller may assign the badge item to content based on the user viewing trend and display other content related to the content to which the badge item is assigned as a recommended content along with the badge item.

In this case, the badge item may include at least one of a content genre badge, a content program badge, a content cast badge, a content viewing pattern badge, and a check-in badge indicating a preference of a user for real-time broadcasting content.

The display apparatus may further include a user interface configured to receive a channel zapping command. In addition, the controller may display the content-related information on a side of a real-time broadcasting content on a screen displayed according to the channel zapping command.

The user preference information may include at least one of a number of sympathized users who expressed preference with respect to the real-time broadcasting content, and Social Network Service (SNS) sharing information with respect to the content.

The controller may provide the user preference information based on at least one of a case that user preference is higher than a predetermined degree or a case that the user preference is raised more than a predetermined rate.

In response to information about the content being corrected, the controller may store the corrected content information and display Electronic Program Guide (EPG) information including the corrected content information based on a predetermined event.

In response to receiving content information which is the same as content information before the correction, the controller may reconstruct and display the received information using the corrected content information.

The controller may transmit and share the corrected content information or the changed EPG information to another user terminal device.

In response to user information being received, the controller may perform a log-in operation based on the user information and store the corrected user information independently for each logged-in user.

According to an aspect of another exemplary embodiment, there is provided a method of controlling a display apparatus including displaying content by adding content-related information to the content. In addition, the content-related information may be generated based on at least one of user preference information and a user viewing trend.

The content-related information may be generated based on a user interaction. In addition, the user interaction may include a user interaction with respect to at least one of the content, an attribute of the content, and at least one object included in the content.

The content-related information may be a badge item that represents a content attribute that is a basis for recommendation of content according to the user viewing trend.

The displaying may include assigning the badge item to the content based on the user viewing trend and providing other content related to the content to which the badge item is assigned as a recommended content along with the badge item.

The badge item may include at least one of a content genre badge, a content program badge, a content cast badge, a content viewing pattern badge, and a check-in badge indicating a preference of a user for real-time broadcasting content.

The displaying may include displaying the content-related information on a side of a real-time broadcasting content displayed according to a channel zapping command.

The user preference information may include at least one of a number of sympathized users that have expressed a preference degree with respect to the real-time broadcasting content and social networking service (SNS) sharing information with respect to the content.

According to the aforementioned various exemplary embodiments, it is possible to provide a user with more various viewing experiences.

### BRIEF DESCRIPTION OF THE DRAWINGS

The above and/or other aspects will be more apparent by describing certain exemplary embodiments with reference to the accompanying drawings, in which:

FIG. 1 is a diagram illustrating a display system according to an exemplary embodiment;

FIGS. 2A and 2B are block diagrams illustrating a display apparatus according to an exemplary embodiment;

FIGS. 3A to 3E are diagrams illustrating examples of various badge items according to exemplary embodiments;

FIGS. 4A and 4B are diagrams illustrating a check-in interaction method according to various exemplary embodiments;

FIGS. 5A and 5B are diagrams illustrating a method of providing recommended content according to various exemplary embodiments;

FIGS. 6A and 6B are diagrams illustrating a method of calculating a user preference with respect to a content according to an exemplary embodiment;

FIGS. 7A to 7D are diagrams illustrating a method of providing a user interface (UI) according to channel zapping according to various exemplary embodiments;

FIGS. 8A to 8F are diagrams illustrating a method of providing EPG information according to various exemplary embodiments;

FIG. 9 is a flow chart illustrating a method of controlling a display apparatus according to an exemplary embodiment; and

FIG. 10 is a flow chart illustrating a method of controlling a display apparatus according to another exemplary embodiment.

### DETAILED DESCRIPTION

Certain exemplary embodiments are described below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, one or more exemplary embodiments may be practiced without those specifically defined matters. Also, well-known functions or constructions are not described in detail because they would obscure the application with unnecessary detail.

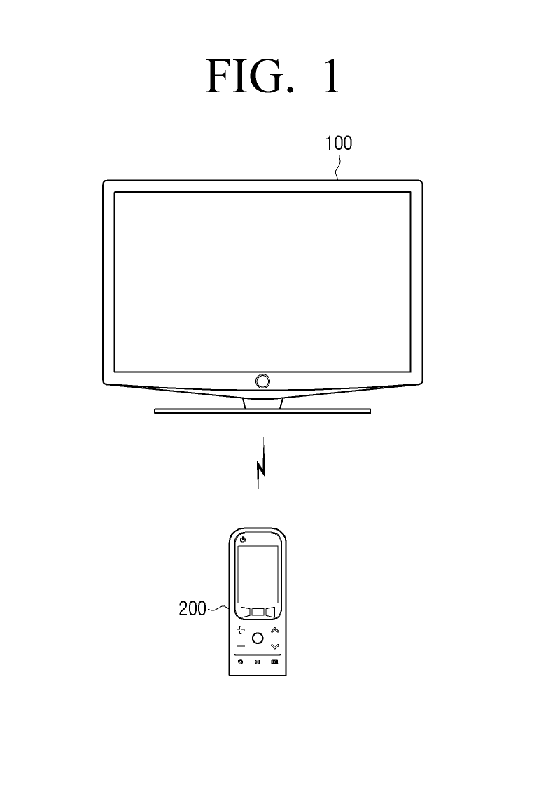

FIG. 1 is a diagram illustrating a display system according to an exemplary embodiment.

Referring to FIG. 1, a display system according to an exemplary embodiment includes a display apparatus 100 and a remote controller 200.

As an example, the display apparatus 100 may be a digital TV as illustrated in FIG. 1, but it is not limited thereto. The display apparatus 100 may be various types of apparatuses having a display function, such as a PC, a mobile phone, a tablet PC, a Portable Multimedia Player (PMP), a Personal Digital Assistant (PDA), a navigation, an appliance, and the like. The display apparatus 100 may also include a touch screen so that a user is able to execute a program using a finger or a pen (for example, a stylus pen.) However, hereinafter, the display apparatus 100 is described as a digital TV for convenience in explanation.

In case of the display apparatus 100 being a digital TV, the display apparatus 100 may be controlled by a user motion, a user voice, the remote controller 200, and the like. In this case, the remote controller 200 is used for controlling the display apparatus 100 remotely. The remote controller 200 may receive a user command and transmit a control signal corresponding to the received user command to the display apparatus 100. For example, the remote controller 200 may sense a movement of the remote controller 200 and transmit a signal corresponding to the sensed movement. In addition, the he remote controller 200 may recognize a vocal command and transmit a signal corresponding to the recognized vocal command or transmit a signal corresponding to an input key. In this case, the remote controller 200 may include a motion sensor, a touch sensor, an optical joystick (OJ) sensor which employs optical technologies, a physical button (for example, a tact switch), a display screen, or a microphone in order to receive various types of user commands.

The display apparatus 100 may provide various UI screens according to a user command received through the remote controller 200. In addition, the display apparatus 100 may provide various functions and information according to various types of user interaction with respect to a UI screen.

For example, when providing content, the display apparatus 100 may provide information generated based on at least one of user preference information and a user viewing trend (or viewing harbit) along with the content. Hereinafter, various exemplary embodiments are described with reference to block diagrams illustrating examples of the display apparatus 100.

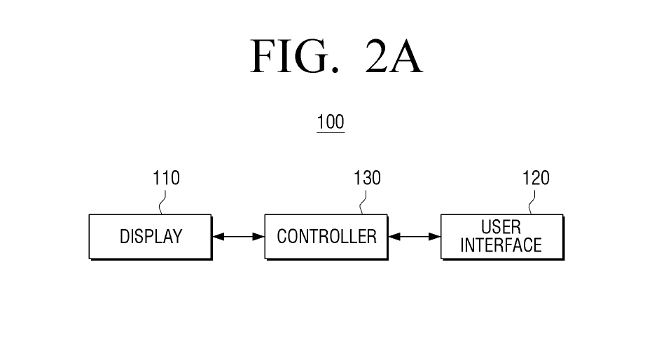

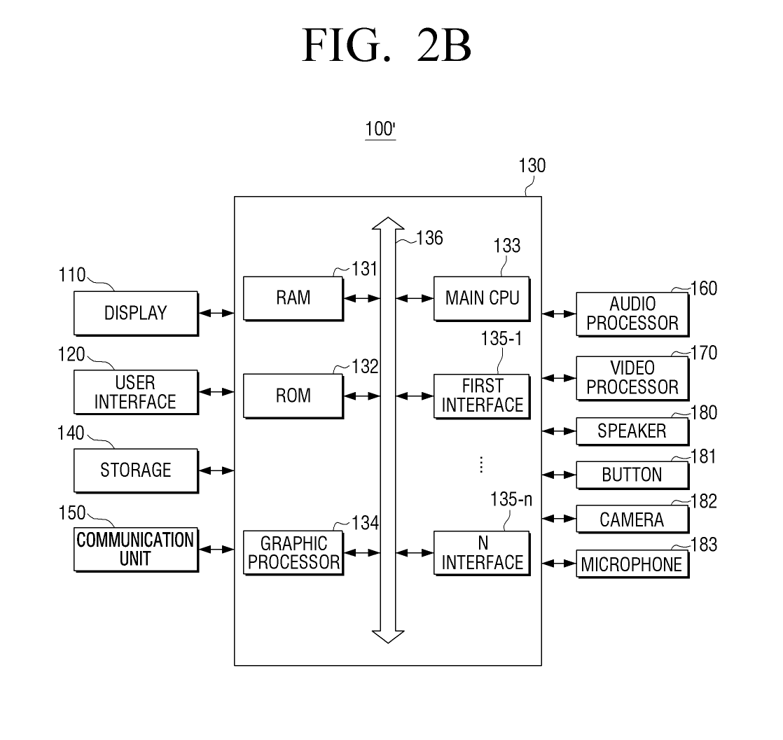

FIG. 2A is a diagram illustrating a display apparatus according to an exemplary embodiment.

Referring to FIG. 2A, the display apparatus 100 includes a display 110, a user interface 120, and a controller 130.

The display 110 displays various screens. In this case, the screen may be used to play back various contents such as an image, a moving image, a text, music, an application execution screen including various contents, a web browser screen, a Graphic User Interface screen, and the like.

In this case, the display 110 may include a liquid crystal display (LCD) panel, an organic light emitting diodes (OLED), and the like, but is not limited thereto. In addition, the display 110 may be a flexible display or a transparent display in some cases.

In response to an occurrence of a predetermined event, the display 110 may provide a content and information corresponding to the content according to control of the controller 130.

The user interface 120 receives various user commands. In this case, the user interface 120 may include various forms according to an embodiment example of the display apparatus 100. In case of the display apparatus 100 being a digital TV, the user interface 110 may be a remote receiver which receives a remote signal from the remote controller 200, a camera which senses a user motion, a microphone which receives a user voice, and the like. In addition, the display apparatus 100 may be a mobile terminal based on a touch. The user interface 120 may be a touch screen which forms a layer structure with a touch pad mutually. In this case, the user interface 110 may be used as the aforementioned display 110.

In particular, the user interface 120 may receive a user interaction with respect to a content displayed on the display 110.

For example, the user interface 120 may receive a content such as a user interaction which expresses preference with respect to a real-time broadcasting content (hereinafter referred to as ‘check-in interaction’). The user interaction may be a pre-set button disposed on the remote controller 200, a predetermined user voice, a predetermined user motion, and the like. As an example, the user interaction may be a user voice “Like” or a user motion of drawing a heart symbol “v.”

In this case, the expression of the preference with respect to a content may be applied to various attributes of the content and objects as well as the content. For example, the expression of a preference may be applied automatically with respect to a program, an episode number, an air time, a scene, a character, an item, sensibility, an image, a background image, audio, and the like.

In some cases, the user interface 120 may receive a check-in interaction with respect to at least one of an attribute of a real-time broadcasting content and an object that is included in the real-time broadcasting content.

For example, a user may input a check-in interaction after selecting a specific genre of a displayed contents or may input a check-in interaction after selecting a character included in the displayed content.

In addition, the user interface 120 may receive a channel zapping command for tuning the real-time broadcasting content. This operation is further described in connection with the controller 130.

The controller 130 controls overall operations of the display apparatus 100. For example, the controller 130 may provide information generated based on at least one of the user preference information and the user viewing trend according to a predetermined event along with the content.

<Providing Recommended Content>

According to an exemplary embodiment, the controller 130 may control an item which is a reason of recommendation when recommending a content.

For example, in providing recommended content, the controller 130 may add and display an item representing a content attribute to the content. In this case, the item may represent the content attribute which is a basis of recommendation according to the user viewing trend.

For example, in response to romance drama content being recommended based on a user viewing trend who likes to watch a drama of a romance genre, an item including a heart symbol ( [symbol] ) which represents romance may be provided along with the recommended content.

The content attributes which are bases of the recommendation may be other various forms other than a genre. For example, the content attributes may be a specific genre (for example, a baseball game, a real variety program, and the like), an air time, a character, an item, sensibility, an image, a background image, audio, a scene, and the like. In this case, a specific genre may be distinguished from an upper class (for example, sports, entertainment, drama, and the like) provided by the EPG information. For example, in response to a drama content appearing in which a particular actor appears being recommended based on a user viewing trend who likes to watch that particular actor, an item including an image representing the actor may be provided with the recommended content.

In addition, the controller 130 may use an item that is to be assigned to a content as an item which is provided with the recommended content based on at least one of a user interaction with respect to the content and other user interaction with respect to the content.

For example, the controller 130 may assign an item corresponding to at least one attribute of the content based on the aforementioned check-in interaction. In this case, the content attribute may be various attributes such as a program, an episode number of the program, a specific genre (for example, baseball, reality TV, and the like), an air time, a character, an item, sensibility, an image, a background image, audio, a scene, etc. The specific genre may be distinguished from an upper class (for example, sports, entertainment, drama, etc.) provided by the EPG information. As an example, an item may be a badge item which symbolically represents common attributes of at least one content which belongs to the item, and may be provided in the form of an icon.

For example, the badge item may include at least one of a content genre badge, a content program badge, a content cast badge, a content viewing pattern badge, and a check-in badge which represent at least one attribute of the content, but the badge is not limited thereto. For example, in response to a predetermined number of check-in interactions being input with respect to a real-time broadcasting content, a first badge item corresponding to a genre of the broadcasting content and a second badge item corresponding to a character of the broadcasting content may be assigned to the content. In this example, the content attribute for providing a badge item may be set by default or may be selected and changed by a user. In addition, the content attribute may be determined by meta data that is included in the content.

The badge item may be pre-produced and stored in the display apparatus 100 or may be automatically generated according to the content attribute. In addition, the badge item may be produced or modified by a user.

The controller 130 may recommend a content based on the badge item provided based on the user interaction with respect to the content and may provide a badge item which is basis of the recommendation with respect to a recommended content. For example, the controller 130 may recommend an episode number of a program that a user having a badge item of the program missed or recommend a new program which is newly added to the badge item.

The controller 130 may provide a badge item to the content based on various conditions. For example, the controller 130 may provide the badge item according to various conditions, such as a number of check-in interactions which are differently determined depending upon a degree of interest and the number of issuing badge items, the number of check-in interactions within a predetermined period, the number of consecutive check-in interactions, the number of check-in interactions according to a first-served system, a frequency of check-in interactions performed concurrently with an acquaintance, and the like, as well as the number of check-in interactions. Accordingly, a user is able to obtain various badge items according to the expression of a preference with respect to the content.

The controller 130 may provide an event badge item based on a point in time. In this case, the event badge item may include a Christmas badge item, a Thanksgiving Day badge item, and the like, as a badge item which may be used in a predetermined period.

While the event badge item is activated, the controller 130 may assign the event badge item based on a check-in interaction. As an example, in response to the Christmas badge item being provided and a check-in interaction being received, the controller 130 may determine whether the content is related to the story of Christmas and assign the corresponding badge item. Accordingly, the user may be provided with content related to Christmas through the Christmas badge item during a certain period. In this example, the controller 130 may provide recommended content related to Christmas along with the Christmas badge item during the certain period.

The controller 130 may provide the recommended content based on user information regardless of a check-in interaction of a user. For example, the controller 130 may provide a corresponding badge item along with the recommended content.

For example, the controller 130 may provide a generation or an age badge item and a gender badge item with the related recommended content. For example, the generation badge item and the gender badge item may include an item such as Kids, Female, Male, and the like.

When providing the recommended content, the controller 130 may receive a user opinion about the contents which belong to the badge item corresponding to the recommended content in the form of poll, reflect the user opinion, and also provide other user's opinion. For example, the controller 130 may reflect or provide user opinions regarding various attribute or objects of a content, such as a scene, an actor, an episode number, a director, music, and the like.

In addition, when providing the recommended content, the controller 130 may provide information on a number of other users that have expressed a preference with respect to the recommended content. For example, the controller 130 may provide information on a number of viewers who watch a certain episode at the same time, the number of viewers who input a check-in interaction with respect to a character of a certain scene, and the like.

<Providing User Preference Information>

According to another exemplary embodiment, the controller 130 may provide user preference information with respect to real-time broadcasting content along with the real-time broadcasting content based on a channel zapping command.

For example, the user preference information may include information on a user interaction such as check-in interaction where another user expresses the preference on the real-time broadcasting content. In this case, the check-in interaction may include a user interaction with respect to at least of the content itself, an attribute of the content, at least one object included in the content, and the like. An example of the check-in interaction is described with reference to the accompanying drawings.

The user preference information may include SNS sharing information about the content. In this example, the SNS sharing information may include various types of information such as an act of capturing and uploading a scene of the content to a SNS sever, an act of writing a reply to the uploaded content scene, an act of expressing a preference through a vote, an act of writing a real-time reply such as with Twitter, and the like.

Meanwhile, the user preference information may include a number of sympathized users that have expressed a preference on the real-time broadcasting content.

As an example, the user preference information may include at least one of a number of users that share the content using a SNS and a number of users that input a check-in interaction with respect to the content. In this case, the number of sympathized users may be displayed as a graphic user interface (GUI) in a speech bubble, but the exemplary embodiments are not limited thereto.

If the user preference exceeds a predetermined level, the controller 130 may provide the user preference information with the real-time broadcasting content provided when performing a channel zapping operation.

For example, in response to at least one of the number of users that share the content using a SNS and the number of users that input a check-in interaction with respect to the content being greater than a predetermined number, the controller 130 may provide the user preference information with the content while performing the channel zapping operation.

In addition, in response to a user preference being above more than a predetermined rate, the controller 130 may provide the user preference information with the real-time broadcasting content while performing the channel zapping operation.

That is, the controller 130 may provide the user preference information with the content while performing the channel zapping operation in an example in which an absolute level of the user preference exceeds a predetermined level as well as in an example in which a relative level of the user preference is above more than a predetermined rate (for example, user preference one minute ago). For example, in response to a number of replies on Twitter about a certain program being increased above a predetermined number within a predetermined period from a point of time in which a particular scene is displayed while the program is broadcasted, the controller 130 may provide user preference information while performing a zapping operation with respect to a corresponding channel.

However, in response to a relative level of the user preference (for example, user preference one minute ago) being raised more than a predetermined rate, the controller 130 may provide a GUI that is separate from the user preference information. For example, in response to a number of check-in interactions about a certain content being sharply increased, an icon or text which symbolically represents the increase with the number of users who input the check-in interaction may be provided.

In addition, the controller 130 may provide a history of preference expression of a user. For example, the user may be recognized using a log-in operation or other user recognition methods. The controller 130 may process the preference expression history of the particular user and use the history in displaying a viewing pattern or interests for recommending a new content.

<Providing EPG Information>

The controller 130 may display EPG information including content information that is corrected according to a predetermined event.

For example, in response to a name of the content being changed by a user command from among content information included in an EPG and the EPG being displayed afterwards according to the predetermined event, the controller 130 may change and display the name of the content included in the EPG.

Meanwhile, in response to receiving other information including content information which is the same as the content information prior to correction, the controller 130 may reconstruct and display the other content information using the corrected content information. For example, in response to a content name being changed and stored based on a user command from among the content information displayed on the EPG, the controller 130 may display an EPG that includes the pre-changed and stored content name even though the same EPG is received again.

In addition, in response to receiving a tag to be input to an EPG, the controller 130 may additionally generate a tag on the EPG by changing the EPG information. In this case, the tag refers to data which may be added to the EPG information through a user input, and the tag may include a form of at least one of an image, a text, a moving image, and the like. For example, in response to a tag being added to the EPG information by a user manipulation, the controller 130 may display an EPG including the added tag and store the EPG including the added tag.

Meanwhile, the controller 130 may transmit and share the corrected content information or changed EPG information to another user terminal device. For example, in response to the content information displayed on the EPG being corrected or the EPG being changed as a tag is additionally added to the EPG information, the controller 130 may store the corrected content information or changed EPG information. As another example, the controller 130 may transmit the corrected content information or changed EPG information to another user terminal device. In addition, the controller 130 may receive and store the content information or EPG information corrected or changed by the other user terminal device.

The controller 130 may generate and store a list of other user terminal devices to transmit or receive the corrected content information or the changed EPG information. In this example, in response to a transmission command with respect to the corrected content information or the changed EPG information being received, the controller 130 may transmit and share the corrected content information or the changed EPG information to a plurality of other user terminal devices that are registered on a pre-stored list.

In response to a user authentication being performed, the controller 130 may independently store the corrected content information in an authenticated user account. For example, in response to a correction of the EPG information or an addition of a tag being performed after a user log-in operation, the controller 130 may display information in which the correction of the EPG information or the addition of the tag is not reflected in a log-out state and may display the corrected EPG information or the added tag in a log-in state.

FIG. 2B is a block diagram illustrating the display apparatus 100 according to another exemplary embodiment. According to FIG. 2B, the display apparatus 100 includes a user interface 120, a controller 130, a storage 140, a communication unit 150, an audio processor 160, a video processor 170, a speaker 180, a button 181, a camera 182, and a microphone 183. In the description of FIG. 2B, the components which overlap the components in FIG. 2A are omitted.

A receiver (not shown) may receive various contents from various sources according to an exemplary embodiment. For example, the receiver may receive various broadcasting signals that are transmitted from a broadcasting station through a Radio Frequency (RF) communication network or may receive content from various servers through an Internet Protocol (IP) network. The structure and a receiving method of the receiver may be variously embodied according to exemplary embodiments.

For example, the receiver may receive the EPG information including various pieces of content information. In this case, the EPG information refers to information including content information that collectively refers to information related to a content. For example, the EPG may include all of the information which belongs to a content, such as a name, a type, a classification, a replay time, a character, a producer, a writer, a broadcasting period, a broadcasting day, a broadcasting time, a synopsis of a content, and the like.

The controller 130 controls the overall operations of the display apparatus 100 using various programs stored in the storage 140.

In this example, the controller 130 includes a Random Access Memory (RAM, 131), a Read-Only Memory (ROM) 132, a main Central Processing Unit (CPU) 133, a graphic processor 134, a first to n interfaces 135-1 to 135-n, and a bus 136.

The RAM 131, the ROM 132, main CPU 133, graphic processor 134, and first to n interfaces 135-1 to 135-n that are connected to each other through bus 136.

The first to n interfaces 135-1 to 135-n are connected to the aforementioned various components. One of the interfaces, for example, may be a network interface that is connected to an external apparatus through a network.

The main CPU 133 accesses the storage 140 and performs a booting operation using an Operating System (O/S) stored in the storage 140. In addition, the main CPU 133 performs various operations using various programs, contents, and data stored in the storage 140.

The ROM 132 stores a command that is set for booting a system. In response to power being supplied in response to receiving a turn-on command, the main CPU 133 copies the O/S stored in the storage 140 into the RAM 131 according to a command stored in the ROM 132 and boots the system by executing the O/S. Upon completion of booting, the main CPU 133 may copy various application programs stored in the storage 140 into the RAM 131 and perform various operations by executing the application programs copied into the RAM 131.

The graphic processor 134 generates a screen including various objects, such as an icon, an image, a text, and the like, using a calculator (not shown) and a rendering unit (not shown). The calculator may calculate an attribute value, such as a coordinate value where the objects are displayed, a shape, a size, a color, and the like, according to a layout of the screen based on a received control command. The rendering unit generates a screen including an object in various layouts based on the attribute value calculated by the calculator. The screen generated by the rendering unit is displayed in a display area of the display apparatus 100.

The storage 140 stores a history of a user interaction that is received through the user interface 120. For example, in response to a check-in interaction regarding a real-time broadcasting content being received, the storage 140 may accumulate and store the received information.

In addition, in response to receiving a check-in interaction with respect to at least one of the attribute of the real-time broadcasting content and an object included in the real-time broadcasting content, the storage 140 may accumulate and store the received information.

The aforementioned operations of the storage 140 may be performed by a program stored in the storage 140.

The storage 140 stores various data such as an O/S software module for driving the display apparatus 100, multimedia contents, applications, contents which are received or set during execution of an application, and the like.

The communication unit 150 communicates with an external apparatus according to various types of communication methods. For example, the communication unit 150 may communicate with a SNS server. In this example, the communication unit 150 may include various communication chips including a Wireless-Fidelity (Wi-Fi) chip, a Bluetooth chip, a wireless communication chip, a Near Field Communication (NFC) chip, and the like.

The controller 130 may receive another user's interaction information about content which belongs to a badge item uploaded to a SNS server and use the information for content recommendation. For example, in response to a content being recommended based on another user's likability information, the controller 130 may provide information about a badge item assigned to a content according the other user's interaction with the recommended content. Accordingly, it is possible to know the other user's likability on the recommended content in detail.

The audio processor 160 processes audio data. The audio processor 160 may perform various processing operations such as decoding, amplifying, noise filtering, and the like, with respect to audio data. For example, the audio processor 160 may provide a feedback sound about the badge item which is provided with the recommended content. Alternatively, the audio processor 160 may generate and provide a feedback sound in an example in which the user preference information displayed in the channel zapping operation satisfies a predetermined level.

The video processor 170 processes video data. The video processor 170 may perform various processing operations such as decoding, scaling noise filtering, frame rate conversion, resolution conversion, and the like, with respect to video data.

The speaker 180 outputs various notification sounds and voice messages as well as various audio data processed by the audio processor 160.

The button 181 may include various types of buttons disposed on an arbitrary area that is included in a front part, a side part, or a rear part on a main body, for example, a physical button, a touch pad, a wheel, and the like. For example, a button for turning on or off the power of the display apparatus 100 may be provided.

The camera 182 is for photographing a still image or a moving image according to user control. For example, the camera 182 may photograph various user motions for controlling the display apparatus 100.

The microphone 183 receives a user voice or other sound that may be used for controlling the display apparatus 100 and may convert the voice or sounds into audio data. The controller 130 may convert the input user voice through the microphone 183 into audio data and use in control of the display apparatus 100. Meanwhile, the camera 182 and the microphone may be part of the user interface 120 according to the function thereof.

The controller 130 may perform a control operation according to a user voice that is recognized by the microphone 183 or a user motion that is recognized by the camera 182. For example, the display apparatus 100 may operate in a motion control mode or a voice control mode. In case of the motion control mode, the controller 130 photographs a user by activating the camera 182 and performing a corresponding control operation by tracing change of the user motion. In case of the voice control mode, the controller 130 may analyze the user voice that is input through the microphone and operate in a voice recognition mode for controlling an operation according to the analyzed user voice.

The display apparatus 100 may further include various external input ports for connecting the display apparatus 100 with various external terminals such as a headset, a mouse, a Local Area Network (LAN), and the like.

FIG. 2B illustrates an example of a structure of the display apparatus 100. But it should be appreciated, according to exemplary embodiments, one or more of the components illustrated in FIG. 2B may be omitted or modified, and other components may be added.

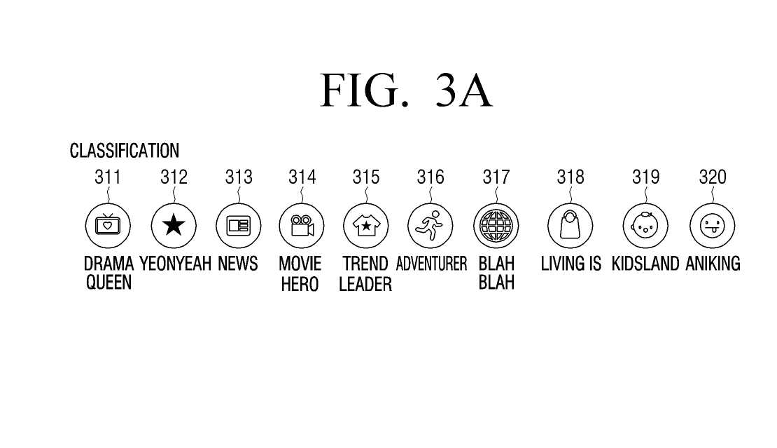

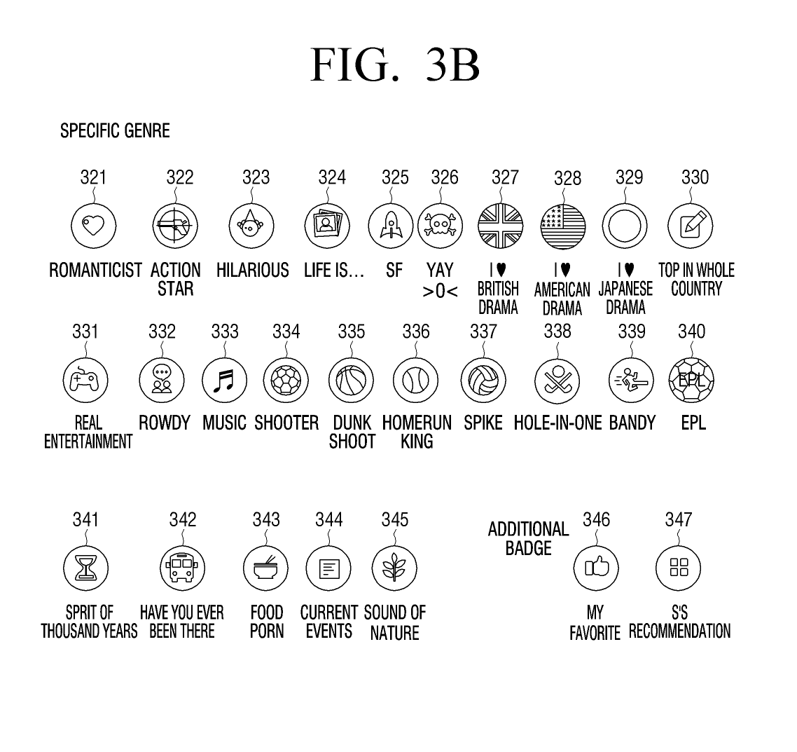

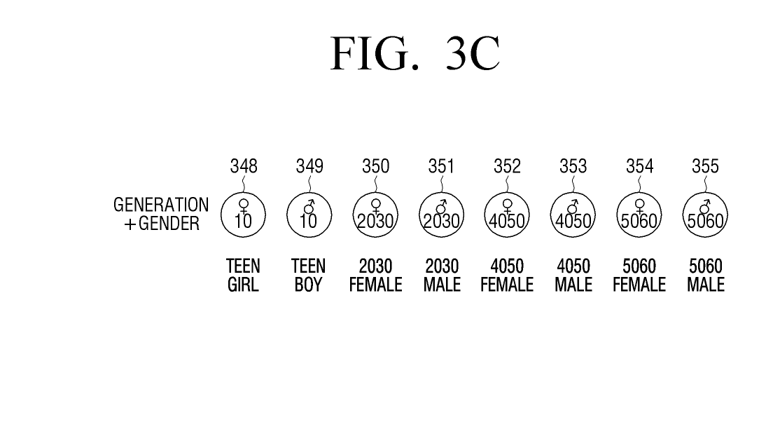

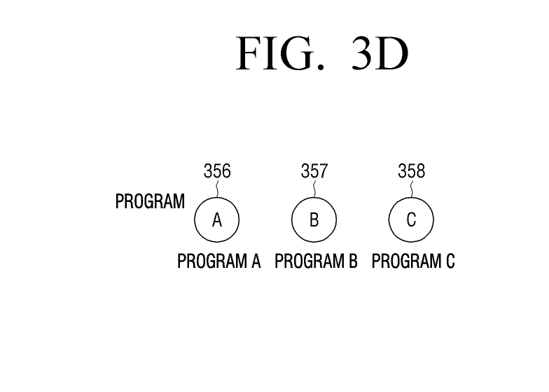

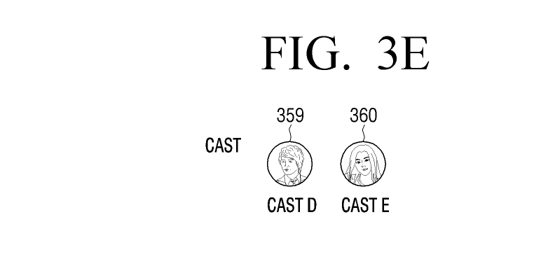

FIGS. 3A to 3E are diagrams illustrating examples of various badge items according to exemplary embodiments.

FIG. 3A is a drawing illustrating badge items that are classified according to various standards. For example, the badge items may include a “Drama queen” badge item 311 representing a drama genre, a “News” badge item 313 representing a news genre, and the like.

FIG. 3B is a drawing illustrating badge items that are classified according to a sub-classification based on an EPG. For example, the badge items may include a “Romanticist” badge item 321 representing a romance drama genre that includes a sub-classification, not a drama genre which is an upper classification, a “US drama” badge item 328 representing an American drama, and the like.

FIG. 3C is a diagram illustrating badge items that are classified according to a generation and a gender. For example, the badge items may include a “10's female” badge item representing a content related to a teen girl, a “5060Male” badge item representing a content related to 50 and 60's men, and the like.

FIG. 3D is a diagram illustrating badge items that are classified according to a program.

FIG. 3E is a diagram illustrating badge items classified according to a cast.

The badge items illustrated in FIG. 3A to 3E may be displayed by default by the display apparatus 100, and be issued based on a check-in interaction history or various events, produced by a user, and the like.

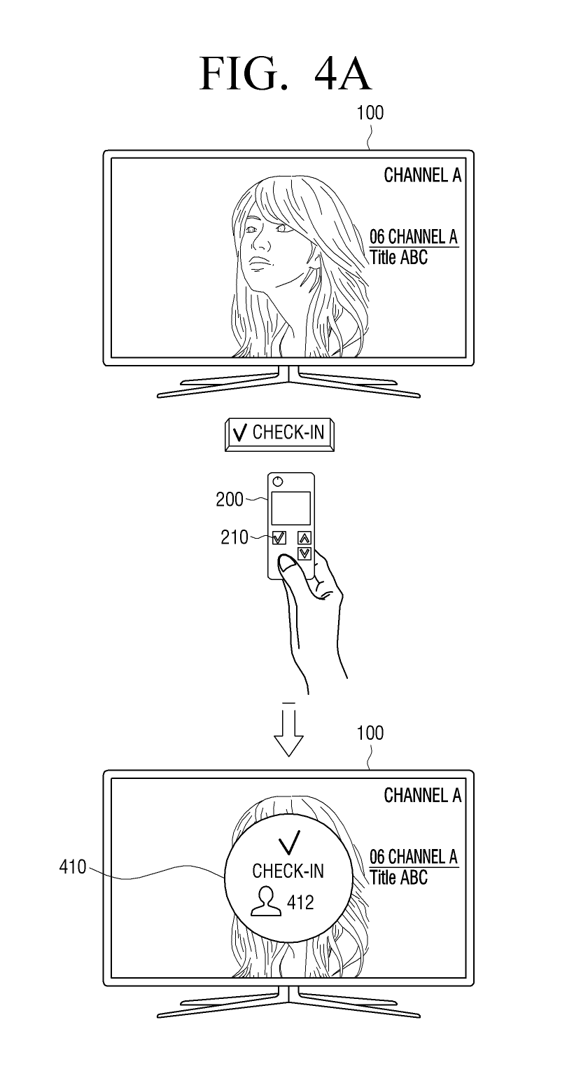

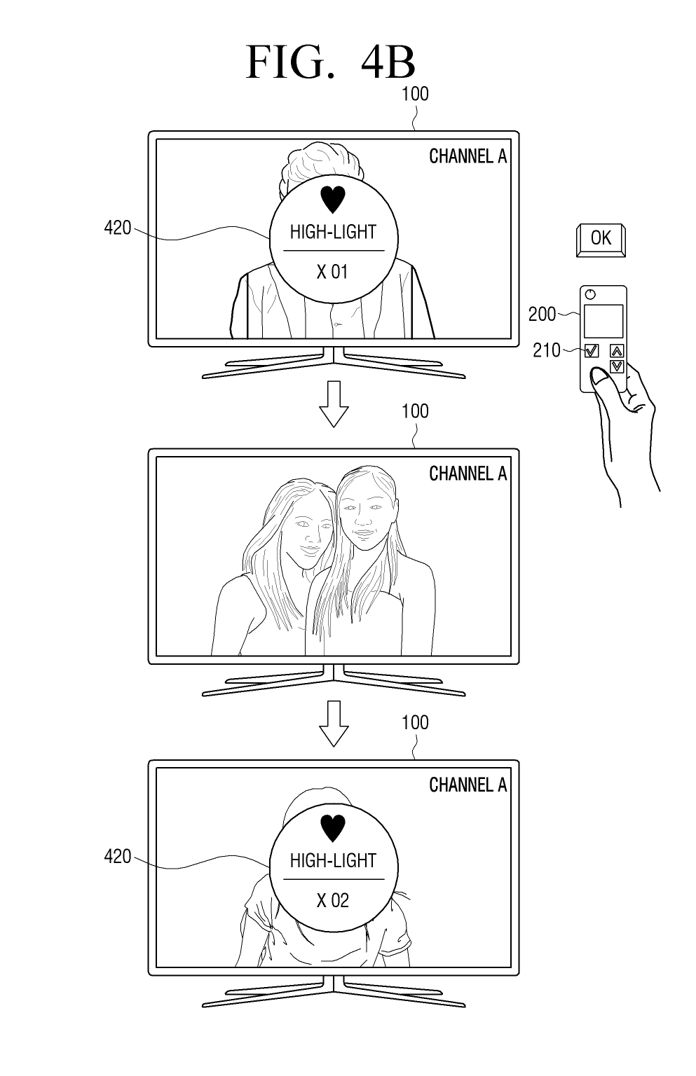

FIGS. 4A and 4B are diagrams illustrating a check-in interaction method according to various exemplary embodiments.

As shown in FIG. 4A, in response to a certain program being broadcasted, a user may input a check-in interaction using predetermined button 210 or a touch pad that is disposed in the remote controller 200. However, in some examples, the check-in interaction may be input by a vocal command or a user motion.

In this case, a GUI 410 which shows input of the check-in interaction may be displayed while being overlapped with an image displayed on a screen. The GUI 410 may include a number of users who have checked in the program. Meanwhile, in some cases, an audio feedback for informing a user of the input of the check-in interaction may be provided with the GUI 410.

As shown in FIG. 4B, a check-in interaction may be input for each scene of the program.

For example, in response to the certain program being broadcasted, the user may be able to input a check-in interaction at a particular scene using a predetermined button or the touch pad disposed on the remote controller 200. In this case, the check-in interaction may be input in a different method from the check-in operation with respect to the program described in connection with FIG. 4A. For example, the check-in operation with respect to the particular scene may be input by a different button, motion, vocal command, or the like.

In this example, a GUI 420 which shows input of the check-in operation with respect to a particular scene may be displayed while being overlapped with an image displayed on a screen. The GUI 420 may include the number of inputs of the check-in operation with respect to the particular scene in the program. For example, referring to the third drawing, the GUI 420 may include a number which shows that the check-in operation with respect to the particular scene was input twice in the program.

According to the check-in interaction as shown in FIGS. 4A and 4B, the badge item that is assigned to content may be used for recommending the content.

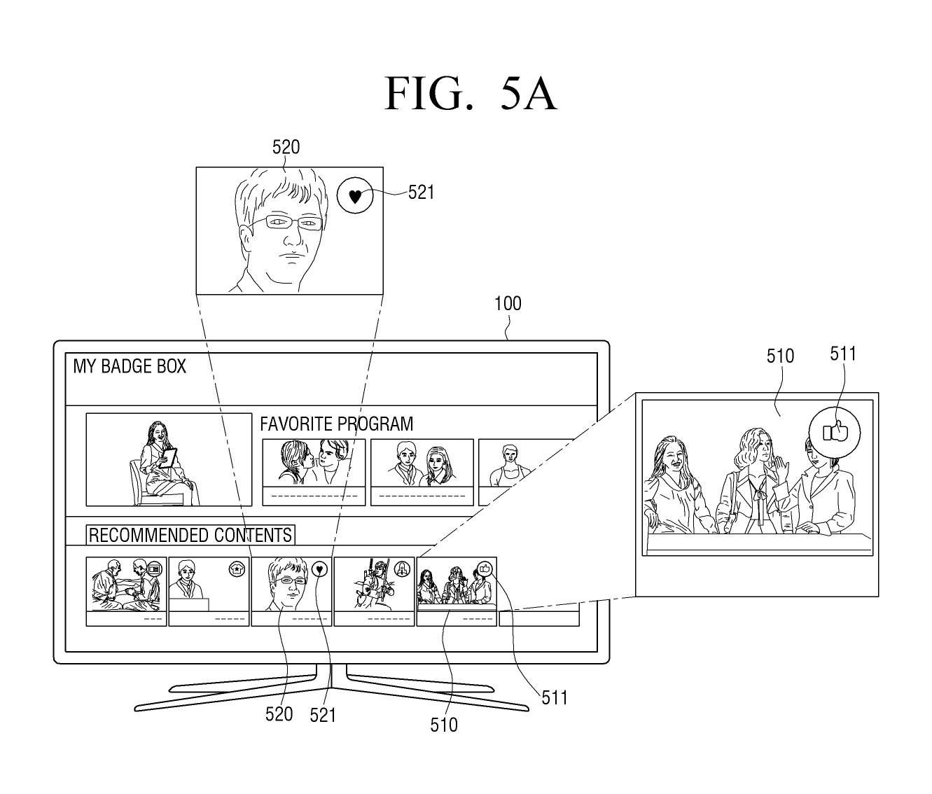

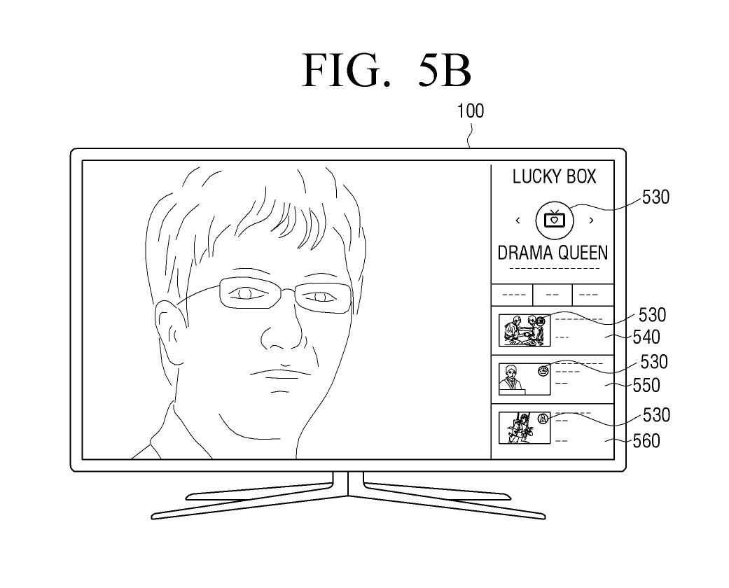

FIGS. 5A and 5B are diagrams illustrating a method of displaying a recommended content according to various exemplary embodiments.

Referring to FIG. 5A, in response to recommended content being provided in a particular menu screen according to a predetermined event, the recommended content may be provided with an item which is the basis of the recommendation.

For example, recommended contents 510 and 520 may be provided with badge items 511 and 522 representing content attributes which are a basis of the recommendation. In this case, the badge item 511 and 522 may represent a content attribute which is basis of the recommendation according to a user viewing trend as described above.

For example, in response to a second recommended content 510 being recommended based on a viewing trend of a user who enjoys to watch a romance drama, the second recommended content 510 may be provided with the badge item 511 representing the attribute of the content.

Accordingly, as the recommended content is provided with the item which is the basis of the recommendation, a user satisfaction may be increased.

According to another exemplary embodiment, as shown in FIG. 5B, the recommended content may be provided on an area of the screen according to a predetermined event while a certain content is being played back.

For example, in response to a content which belongs to the “Drama queen” badge item 530 being played back, contents 540, 550, and 560 related to the badge item 530 may be displayed as recommended content along with the badge item 530.

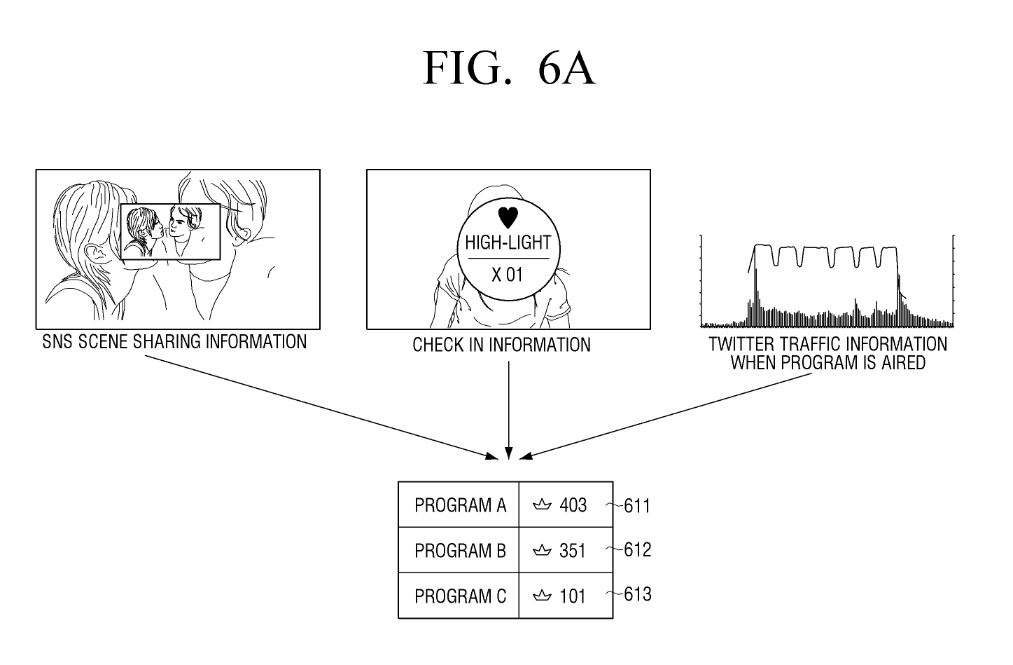

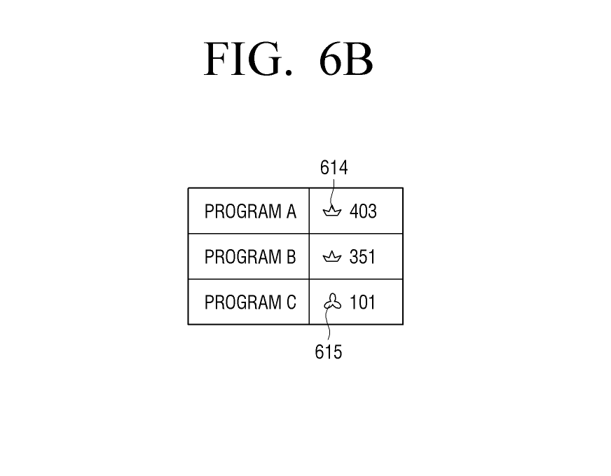

FIGS. 6A and 6B are diagrams illustrating a method of calculating a user preference with respect to content according to an exemplary embodiment.

As shown in FIG. 6A, user preference 611 to 613 with respect to a content may be calculated based on at least one of SNS sharing information, check-in interaction information with respect to the content, Twitter traffic information while the content is broadcasted, and the like. For example, the preference based on each information may be calculated separately or in a lump sum. In addition, in an example in which the preference is calculated in a lump sum, it is possible to assign a different weighted value to each information.

Meanwhile, the operation of calculating the user preference with respect to content may be performed by the display apparatus 100 or an external server (not shown). As an example, in response to the external server calculating the user preference with respect to the content and transmitting the calculated information to the display apparatus 100, the display apparatus 100 may display the preference with respect to the content based on the received information.

In addition, as shown in FIG. 6B, the preference information of the content may be classified into different levels according to a degree of the preference. For example, the classified levels according to a degree of the preference may be divided into different items 614 and 615 and may be provided.

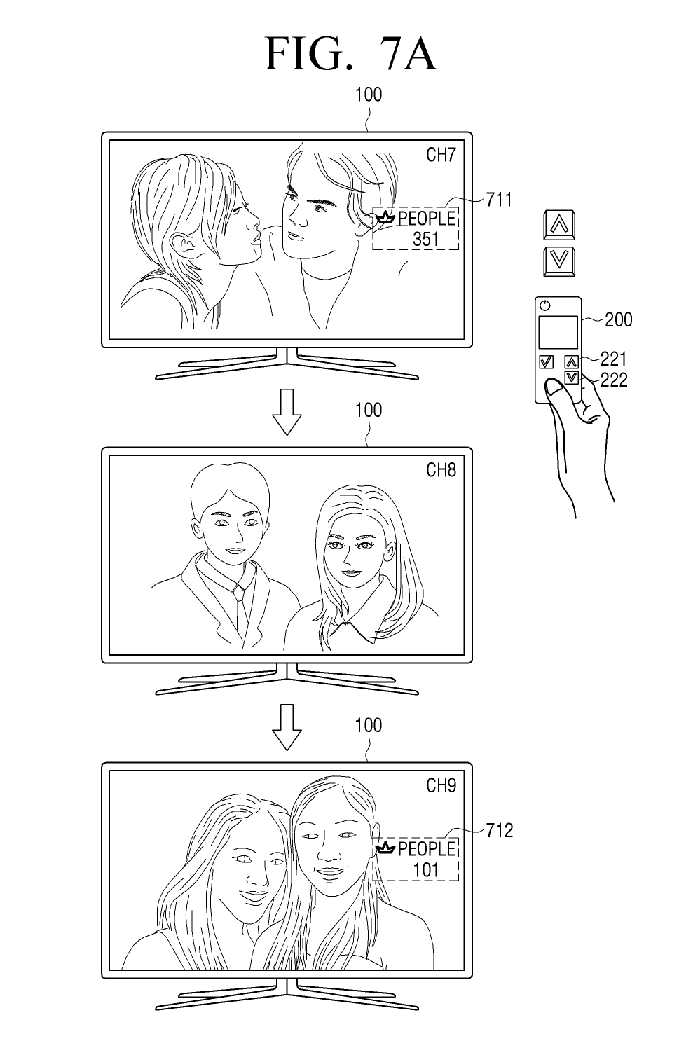

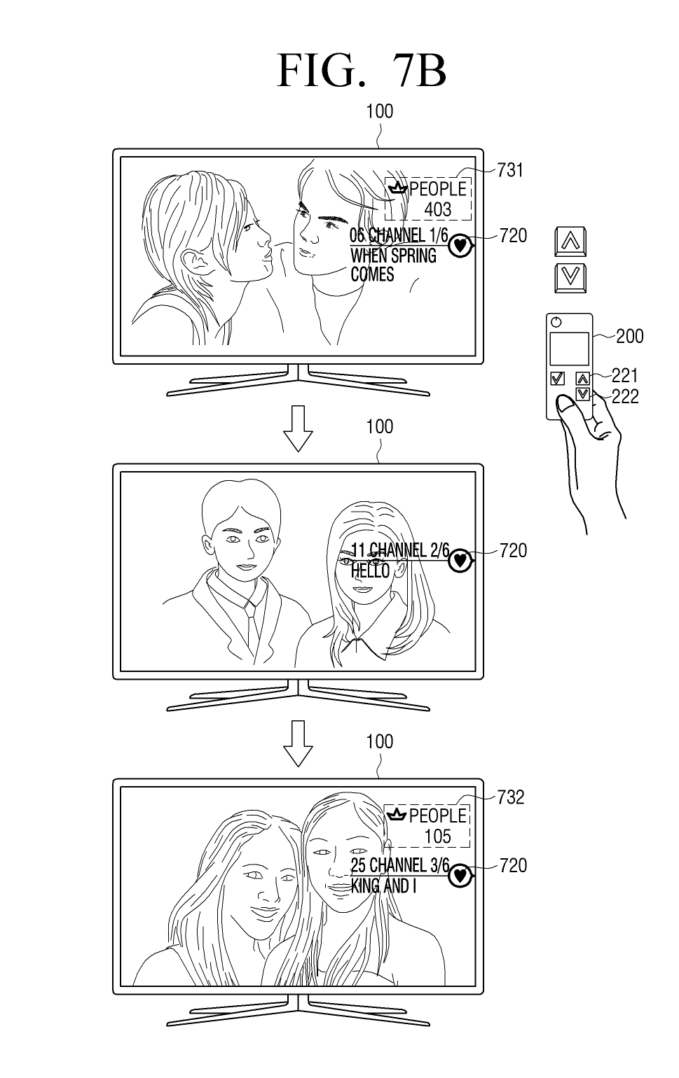

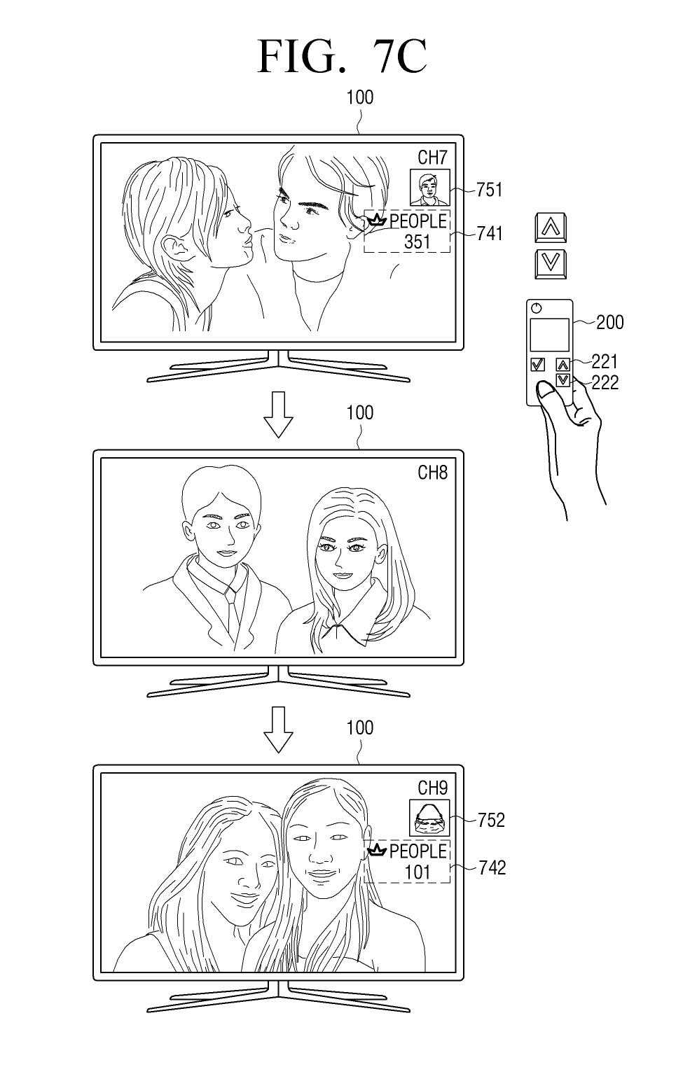

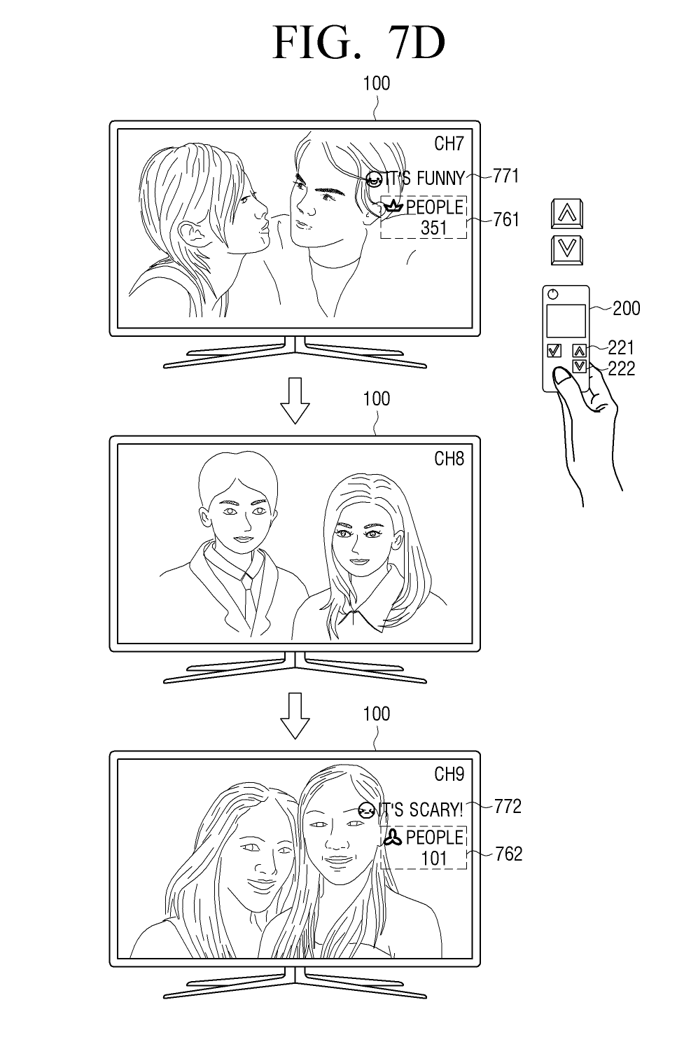

FIGS. 7A to 7D are diagrams illustrating a method of providing a User Interface (UI) according to channel zapping according to various exemplary embodiments.

Referring to FIG. 7A, user preference information 711 and 712 may be displayed together on a real-time broadcasting content that is provided according to a channel zapping command.

For example, in response to CH7 being tuned to according to the channel zapping command, a first preference information 711 corresponding to the tuned channel may be displayed, In response to CH8 being tuned to, preference information may not be displayed. In addition, in response to CH9 being tuned to, a second preference information 712 corresponding to the tuned channel may be displayed.

In this example, as in a case that CH8 is tuned to, the preference information may not be displayed unless the user preference exceeds the predetermined level. However, as another example, the preference information may be provided even when the user preference does not exceed the predetermined level.

For example, the displayed preference information may include information about a user who has expressed sympathy with respect to the content in various methods. For example, the preference information may include information on a user who has expressed sympathy with respect to the content based on at least one of the check-in interaction and the SNS sharing information.

According to another exemplary embodiment, as shown in FIG. 7B, it is possible to provide user preference information 731 and 732 which are displayed with the channel tuned according to the channel zapping command along with a badge item 720 which allows the content to be classified and identified according to a predetermined standard and displayed based on the user interaction.

In this example, the badge item 720 may correspond to at least one content attribute which is assigned to the content based on a history regarding the check-in interaction with respect to the content. For example, the content attributes may be various attributes, such as an episode number, a specific genre (for example, baseball, a variety program, and the like), an air time, a character, an item, sensibility, an image, a background image, audio, a scene, and the like. In this example, the specific genre may be distinguished from an upper class (for example, sports, entertainment, drama, etc.) provided by the EPG information.

According to another exemplary embodiment, as shown in FIG. 7C, user preference information 741 and 742 displayed with the channel tuned according to the channel zapping command may be provided with items 751 and 752, respectively, which represent an object related to the preference information.

For example, in response to the preference information being related to the preference information of an actor which appears in a content provided in the channel, actor images 751 and 752 may be provided with the preference information 741 and 742.

According to another exemplary embodiment, as shown in FIG. 7D, the user preference information 761 and 762 displayed with the channel tuned according to the channel zapping command may be provided with items 771 and 772 which respectively represent sensibility information about a user who relates to the preference information.

For example, in response to the sensibility information being input when users express the preference on the content, the input sensibility information may be provided with the user preference information to be of assistance in a selection of content of other users. In this example, the sensibility information may include an icon, but is not limited thereto.

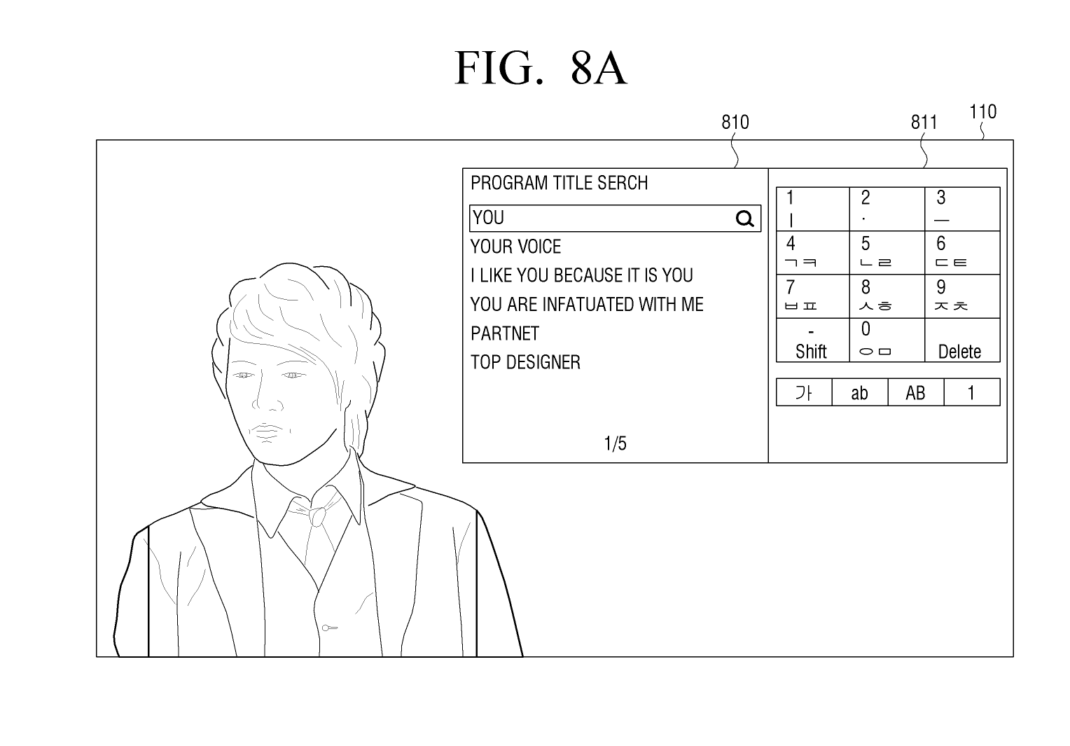

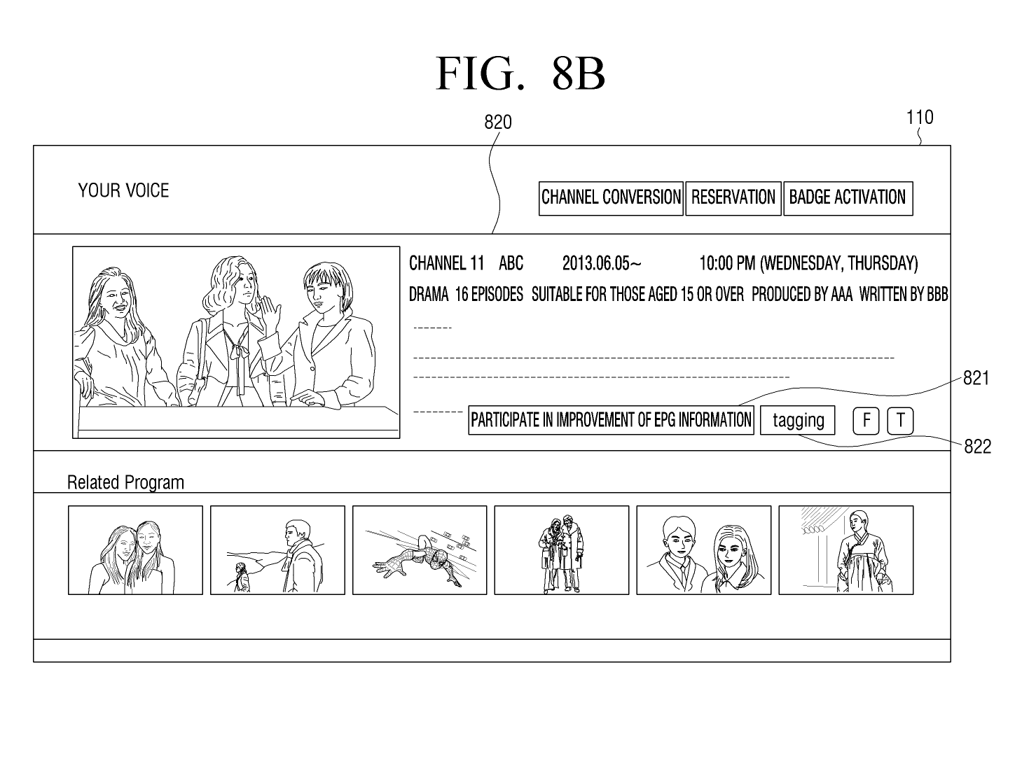

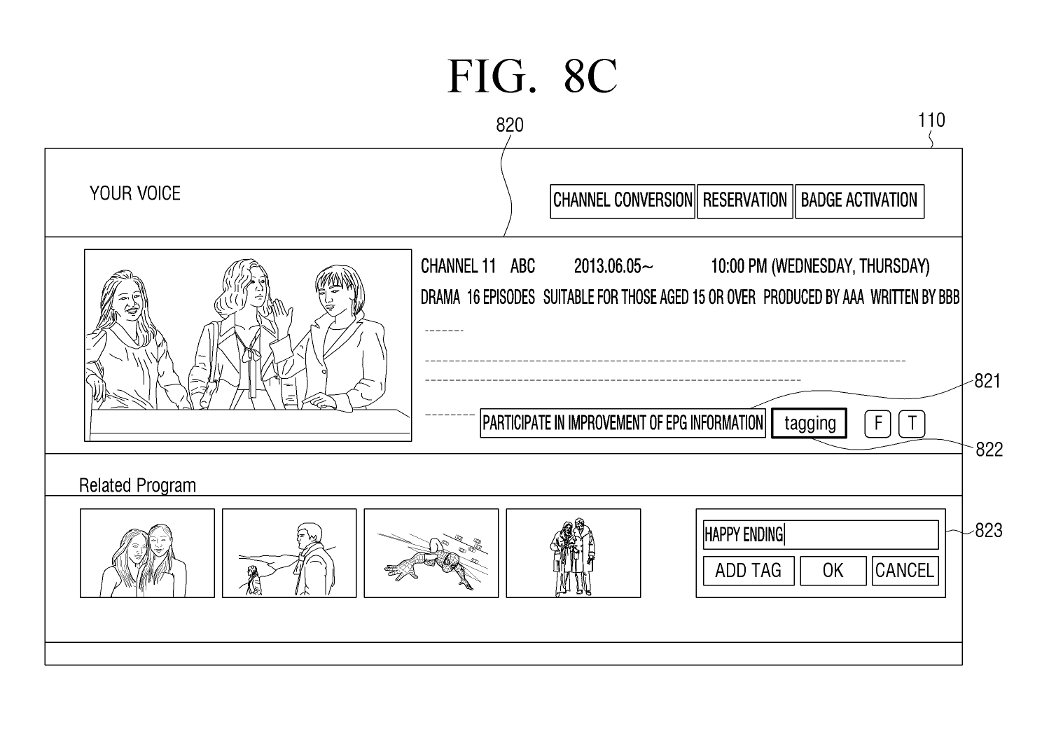

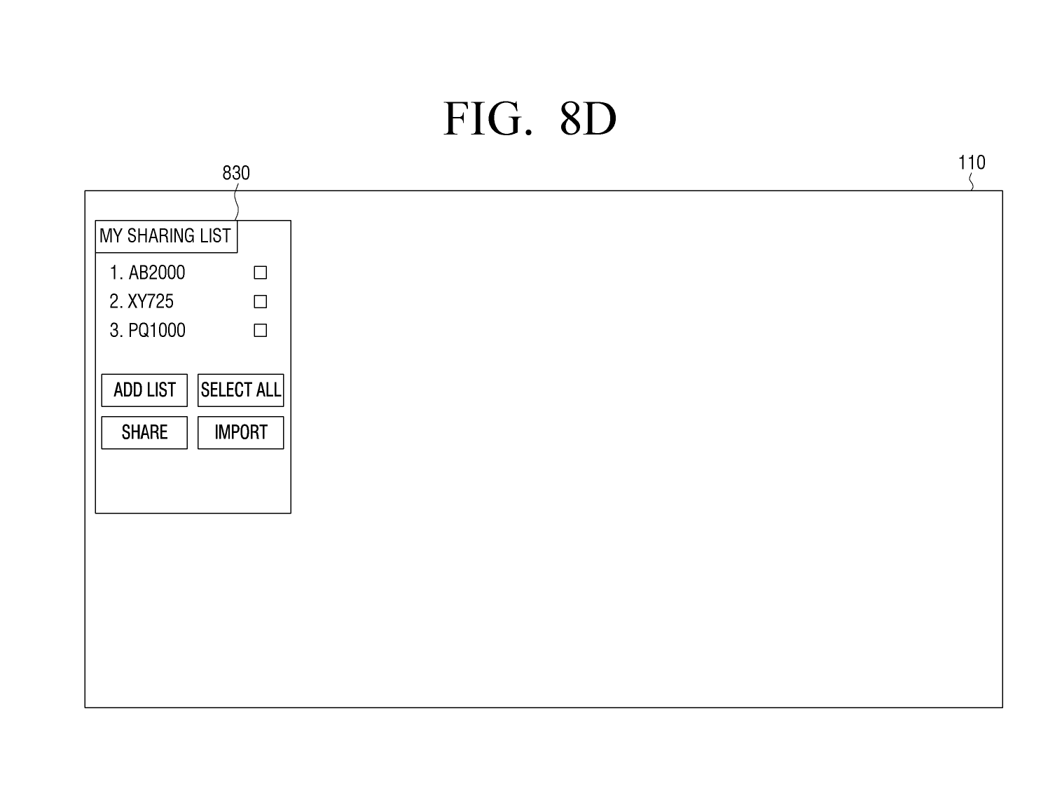

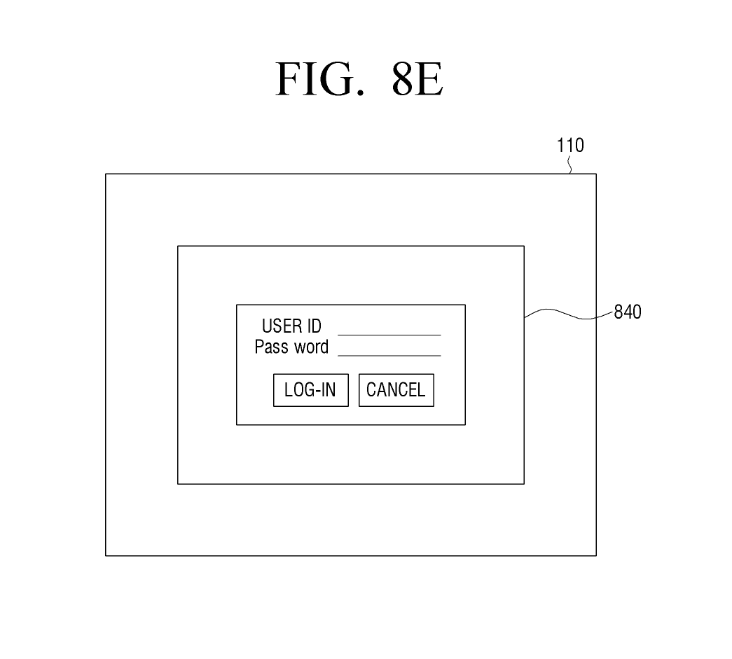

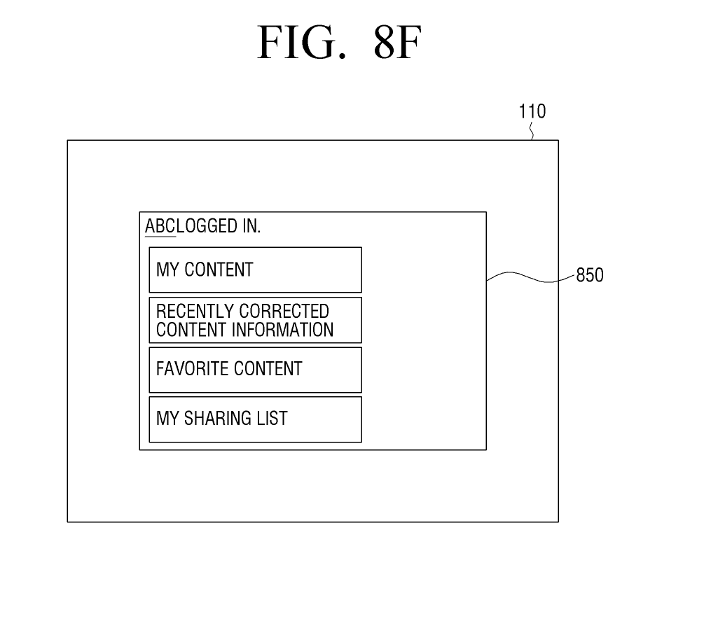

FIGS. 8A to 8F are diagrams illustrating a method of providing EPG information according to various exemplary embodiments.

FIG. 8A is a drawing illustrating a UI that is used for correcting content information. For example, FIG. 8A shows an example of a screen where a content name among the content information is corrected.

That is, as illustrated in FIG. 8A, in response to the content information to be corrected being selected from a UI which displays the EPG information, the UI for correcting the content information may be displayed on a search box 810 and an input box 811. In this example, in response to a text to be changed being input into the input box 811 through a remote controller, a mobile phone, or a touch input, the search box 810 may display a recommended text which starts with the input text.

For example, as shown in FIG. 8A, even though only the letters “you” are inputted by a user, a recommended text which starts with or includes “you” may be displayed in the search box 810. Accordingly, in response to the recommended text displayed on the search box 810 being selected, the content information may be corrected to the selected recommended text, or corrected to the entire inputted text.

In response to the content information being corrected through the UI, the controller 130 may control the storage 140 to store the corrected content information. Subsequently, as shown in FIG. 8B, in response to an event where the EPG information should be displayed again occurring (for example, because of a user choice), the controller 130 may control the changed EPG including the corrected content information.

FIG. 8B is a diagram illustrating a UI 820 for displaying an EPG corresponding to EPG information. The EPG information may include a plurality of pieces of content information. For example, the content information may include all information which corresponds to the content, such as a name, a broadcasting period, a broadcasting day, a broadcasting time, a type, a classification, a producer, a character, a synopsis of the content, and the like. Through the EPG illustrated in FIG. 8B, the user is able to check information on the content.

Meanwhile, the UI 820 for displaying an EPG may include a button 821 for displaying a UI for correcting content information of the EPG. That is, in response to the button 821 for displaying a UI of correcting content information of the EPG being selected, a content information correction mode of the EPG may start. In addition, in response to a content name being selected from the content information correction mode, a UI for correcting content information on the content name may be displayed as shown in the example of FIG. 8A.

In addition, a UI for displaying an EPG may include a tagging button 822 which when selected is capable of adding a user tag. The user tag refers to data which may be added to EPG information by a user input. For example, the tag may exist in the form of an image, a text, a moving image, and the like.

Accordingly, in response to the tagging button 822 being selected, the controller 130 may display a UI 823 for adding a tag to an EPG as shown in FIG. 8C. That is, a user may be able to select the tagging button 822 in order to add their own tag to the EPG.

An example of a user tagging method is described with reference to the UI 823 of adding a tag to an EPG as shown in FIG. 8C.

In response to the tagging button 822 included in the UI 820 of displaying an EPG being selected, a UI 823 for adding a tag to an EPG may be overlapped with a periphery of the tagging button 822.

A text may be input to the UI 823 for adding a tag to an EPG as a tag as illustrated in FIG. 8C, but an image or a moving image may be input as a tag. In response to a tag being input to the UI 823 for adding a tag to an EPG and an OK button being pressed, a tag may be included in the UI 820 for displaying an EPG and displayed.

For example, the controller may correct and store the EPG by including a user tag, and in response to an event where the EPG information should be displayed later, may display an EPG including a user tag.

For example, in response to an image where a certain scene of a ‘happy ending,’ ‘happy drama,’ and a content is captured being tagged through the UI 820 for adding a tag to an EPG, the controller may store the user tag. As another example, in response to an event occurring where the EPG information should be displayed later, the controller may display the image where a certain scene of a ‘happy ending,’ a ‘happy drama,’ and a content is captured on a part of the UI 820 of displaying an EPG.

Meanwhile, FIG. 8D is a drawing illustrating an example of a list UI 830 of other user terminal devices for sharing information. The list UI 830 of other user terminal devices may include a list of other user terminal devices for sharing content information or an EPG.

For example, in response to four types of display apparatuses being used in an office, each display apparatus may share the EPG information and the content information of the EPG information with other display apparatuses through a communication unit. Accordingly, as shown in FIG. 8D, a display apparatus may insert the other three display apparatuses in a sharing list.

The sharing list illustrated in FIG. 8D refers to arbitrary names of the other display apparatuses. The names of the other display apparatuses may be set as a value which is input into each display apparatus as a default value, or may be changed to another name by a user input.

Meanwhile, FIGS. 8E and 8F are diagrams illustrating a user log-in UI 840 and a menu 850 that a logged-in user is able to use.

That is, in case that there are multiple users that use the display apparatus 100 and each user wishes to correct the content information and store the corrected content information according to their needs, a user log-in function may be used.

For example, in response to each user's Identification (ID) and a password being input, the controller 130 may perform a log-in operation based on the input information. In response to a user manipulation for correcting the content information or adding a sharing list being input after the log-in operation, the controller 130 may store the input details independently for each logged-in user.

In addition, in response to the log-in operation being performed, as shown in FIG. 8F, the display 120 may display a menu 850 that the logged-in user is able to use.

That is, in response to a user log-in operation being executed, the controller 130 may display the menu 850 which may be used for each user so that the user is able to easily manipulate the display apparatus 100.

For example, the menu 850 may include “My contents” for displaying a content that is designated by a user choice, “Recently corrected content information” for displaying the content information that is corrected by a user manipulation or an EPG including the corrected content information, “Favorite contents” for displaying the contents which are frequently selected by the user according to the frequency of selection, and “My sharing list” for displaying a list of other display apparatuses which may share the content information or the EPG. However, this is merely an exemplary embodiment. The menu 850 which may be used according to a setting of the display apparatus 100 or the user selection may display various lists.

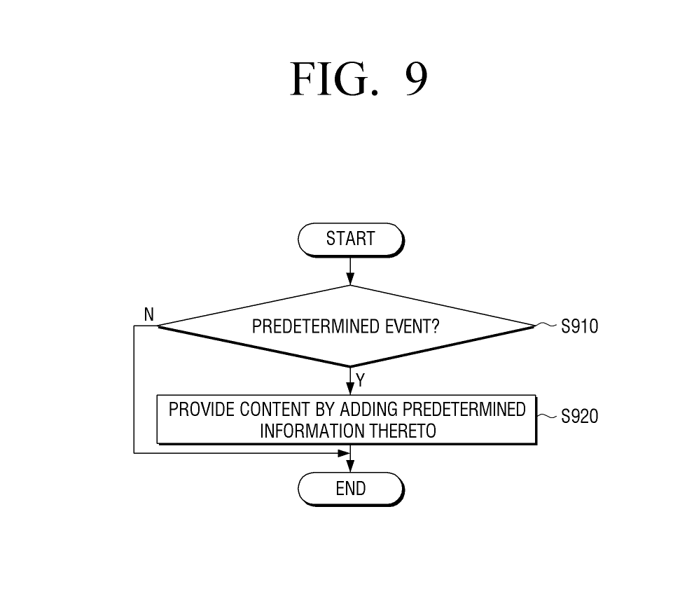

FIG. 9 is a flow chart illustrating a method of controlling a display apparatus according to an exemplary embodiment.

According to the method of controlling a display apparatus illustrated in FIG. 9, in response to a predetermined event occurring (S910:Y), predetermined content-related information is added to a content and is displayed (S920). For example, the content-related information may be information which is generated based on at least one of user preference information and a user viewing trend. In addition, the predetermined event may be an event to which a channel zapping command, a recommended content providing command, and an EPG providing command are input.

The content-related information may be generated based on a user interaction with respect to the content, and the user interaction with respect to the content may include a user interaction with respect to at least one of the content itself, a content attribute, at least one object included in the content, and the like.

In addition, the content-related information may be a badge item which may be used to symbolically represent the content attribute which is basis of recommendation according the user viewing trend.

In S920, the badge item may be assigned to the content based on the user viewing trend. Also, other content related to the content to which the badge item is assigned may be provided as a recommended content along with the badge item. In this example, the badge item may include at least one of a content genre badge, a content program badge, a content cast badge, a content viewing pattern badge, and a check-in badge. In S920, user preference information about a real-time broadcasting content provided according to a channel zapping command may be provided. For example, the user preference information may include at least one of a number of sympathized users that have expressed a preference on the real-time broadcasting content and SNS sharing information on the content.

In S920, the user preference information may be provided based on at least one of a case of the user preference exceeding a predetermined level and a case of the user preference being raised above a predetermined rate.

In S920, EPG information including content information corrected according to a user interaction may be displayed.

In S920, in response to other information including content information which is the same as the content information before correction being received, the other information may be reconstructed and displayed using the corrected content information.

The method of controlling a display apparatus may further include transmitting and sharing the corrected content information or the changed EPG information to another user terminal device.

In response to user information being received, the method may further include performing a log-in operation based on the user information and storing the content information that is corrected independently for each logged-in user.

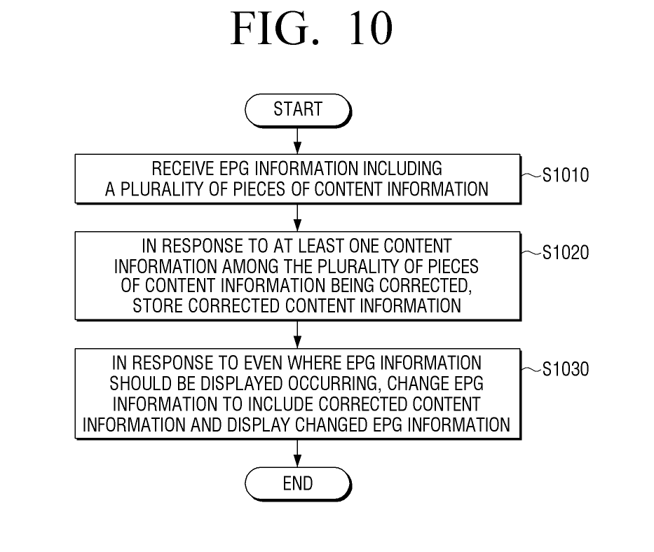

FIG. 10 is a flow chart illustrating a method of controlling a display apparatus according to another exemplary embodiment.

Referring to FIG. 10, display apparatus 100 receives EPG information including a plurality of pieces of content information (S1010).

Subsequently, in response to at least one content information among the plurality of pieces of content information being corrected, the display apparatus 100 stores the corrected content information (S1020.) The content information includes the information which belongs to a content, such as a name, a broadcasting period, a broadcasting day, a broadcasting time, a type, a classification, a character, a producer, a synopsis of a content, and the like. Accordingly, in response to correction of the content name being selected by a user manipulation and the corrected content name being received, the display apparatus 100 stores the corrected content information.

In response to an event occurring in which EPG information should be displayed, the display apparatus 100 changes the EPG information to include the corrected content information and displays the changed EPG information (S1030). That is, in response to the content information being corrected and the corrected content information being stored, the display apparatus 100 may display an EPG including the corrected EPG information.

According to one or more exemplary embodiments, information related to a content, such as a content name, a content type, and the EPG is described as including and displaying the content information, but the present disclosure is not limited to the EPG. That is, the EPG in the present disclosure includes all components which represent information related to a content.

Accordingly, a user is able to correct the content information which was received wrongly or which does not satisfy their needs and reflect the corrected content information to the EPG or add an additional tag to the EPG. In addition, the user is able to share the corrected EPG information with other user terminal devices and log in to the display apparatus 100 to manage their own EPG.

Meanwhile, the method of controlling a display apparatus according to an exemplary embodiment may be executed by an Application which is software that the user uses on an O/S. In addition, the Application may be provided on a screen of the display apparatus 100 in a form of an icon interface, but not limited thereto.

As described above, according to various exemplary embodiments, it is possible to provide a user with various TV viewing experiences.

For example, the display apparatus may perform various operations, but the aforementioned various operations may also be performed in a server which communicates with the display apparatus.

The method of controlling a display apparatus according to an exemplary embodiment may be embodied as a program code which is executable by a computer and which is provided to a server or an apparatus so that the program code is executed by a processor by being stored in various types of non-transitory computer readable medium.

The non-transitory computer readable medium refers to a medium which may store data semi-permanently or permanently rather than storing data for a short time such as a register, a cache, and a memory and may be readable by an apparatus. Specifically, the above-described various applications and programs may be stored in the non-transitory computer readable medium like a compact disc (CD), a digital versatile disk (DVD), a hard disk, a Blu-ray disk, a universal serial bus (USB), a memory card, and a read-only memory (ROM), etc., and provided therein.

As given above, although a few exemplary embodiments have been shown and described, the present disclosure is not limited to the aforementioned exemplary embodiments, and could be variously modified and achieved by those skilled in the art to which the present disclosure pertains without deviating from the substance of the present disclosure which is claimed in the claims. Also, such modifications should not be understood separately from the technical concept or prospect of the present disclosure.

What is claimed is:

1. A display apparatus comprising:
a display configured to display content; and
a controller configured to control the display to display the content by adding content-related information, that is generated based on at least one of user preference information and a user viewing trend, to the content.

2. The apparatus of claim 1, wherein the content-related information is generated based on a user interaction, and
the user interaction comprises a user interaction with at least one of the content, an attribute of the content, and at least one object that is included in the content.

3. The apparatus of claim 1, wherein the content-related information comprises a badge item that represents content attributes which are a basis for recommendation of content according to the user viewing trend.

4. The apparatus of claim 3, wherein the controller is configured to display the badge item on an area of a screen and display a thumbnail with respect to at least one content which corresponds to the badge item on another area of the screen.

5. The apparatus of claim 3, wherein the controller is configured to assign the badge item to content based on the user viewing trend and also display other content related to the content to which the badge item is assigned as a recommended content along with the badge item.

6. The apparatus of claim 3, wherein the badge item comprises at least one of a content genre badge, a content program badge, a content cast badge, a content viewing pattern badge, and a check-in badge indicating a preference of a user for real-time broadcasting content.

7. The apparatus of claim 1, further comprising:
a user interface configured to receive a channel zapping command,
wherein the controller is configured to display the content-related information on a side of a real-time broadcasting content on a screen displayed according to the channel zapping command.

8. The apparatus of claim 1, wherein the user preference information comprises at least one of a number of sympathized users who expressed a preference degree with respect to the real-time broadcasting content, and social networking service (SNS) sharing information with respect to the content.

9. The apparatus of claim 8, wherein the controller is configured to provide the user preference information based on at least one of a case that a user preference degree is higher than a predetermined degree or a case that the user preference degree is raised more than a predetermined rate.

10. The apparatus of claim 1, wherein, in response to information about the content being corrected, the controller is configured to store the corrected content information and display Electronic Program Guide (EPG) information including the corrected content information based on a predetermined event.

11. The apparatus of claim 10, wherein, in response to receiving content information which is the same as content information before the correction, the controller is configured to reconstruct and display the received information using the corrected content information.

12. The apparatus of claim 11, wherein the controller is configured to transmit and share the corrected content information or the changed EPG information to another user terminal device.

13. The apparatus of claim 11, wherein, in response to user information being received, the controller is configured to perform a log-in operation based on the user information and store the corrected user information independently for each logged-in user.

14. A method of controlling a display apparatus, the method comprising:
displaying content by adding content-related information to the content,
wherein the content-related information is generated based on at least one of user preference information and a user viewing trend.

15. The method of claim 14, wherein the content-related information is generated based on a user interaction, and
the user interaction comprises a user interaction with respect to at least one of the content, an attribute of the content, and at least one object included in the content.

16. The method of claim 14, wherein the content-related information comprises a badge item that represents a content attribute which is a basis for recommendation of content according to the user viewing trend.

17. The method of claim 16, wherein the displaying comprises assigning the badge item to the content based on the user viewing trend and providing other content related to the content to which the badge item is assigned as a recommended content along with the badge item.

18. The method of claim 16, wherein the badge item comprises at least one of a content genre badge, a content program badge, a content cast badge, a content viewing pattern badge, and a check-in badge indicating a preference of a user for real-time broadcasting content.

19. The method of claim 16, wherein the displaying comprises displaying the content-related information on a side of a real-time broadcasting content displayed according to a channel zapping command.

20. The method of claim 14, wherein the user preference information comprises at least one of a number of sympathized users that have expressed a preference degree with respect to the real-time broadcasting content and social networking service (SNS) sharing information with respect to the content.
